(19) United States
(12) Patent Application Publication
(10) Pub. No.: US 2012/0074841 A1
(43) Pub. Date: Mar. 29, 2012

(54) AUTOMOBILE LIGHT EMITTING DEVICE

(76) Inventors: CHANG - SHENG LIU, New Taipei City (TW); Feng-Chiau Yeh, New Taipei City (TW)

(21) Appl. No.: 13/161,892

(22) Filed: Jun. 16, 2011

(30) Foreign Application Priority Data
Sep. 29, 2010 (TW) 099218775

(51) Int. Cl. B60Q 1/14

(52) U.S. Cl. 315/77

(57) ABSTRACT

An automobile light emitting device includes a plurality of light emitting members, a control unit and an electric connection circuit. Each light emitting member is installed at an external peripheral surface (such as a fender, a wheel arch panel or a wheel housing panel) of an automobile wheel, a door handle or a door handle recess of a car door, or a car roof (such as a car antenna, a convertible top rack or an automobile shark fin), and the control unit is linked to an automobile signal light control circuit or a central lock control unit for controlling and turning on each light emitting member timely to achieve the goals of providing warnings, safety, and convenience to users, allowing the users to find their cars easily and reduce the occurrence of car accidents effectively.

### BACKGROUND OF THE INVENTION

1. Field of the Invention

The present invention relates to an automobile light emitting device, not only reducing car accidents, but also providing a warning effect to improve the safety of drivers and passengers.

2. Brief Description of the Related Art

A blinking signal light is provided for warning and reminding nearby passengers, bicycle riders or motorcycle riders while a car is making a turn, and preventing accidents when the car is getting too close. However, nearby passengers, bicycle riders or motorcycle riders have to pay attention to the conditions of the road ahead and may not be able to notice a car in another lane getting ready for a street parking or making a left or right turn under a poor visual condition or an over-speed condition, and people may be injured in all kinds of car accidents.

Furthermore, car owners may not be able to locate the position of their car in a large parking lot or a mall. Although beep sounds or lit signal lights are provided for reminding the car owners, the exact position of the car cannot be located easily if the owner's car is blocked by other cars.

In poor weather conditions such as heavy rain, a driver may enter into the car and open the locks of all car doors, but passengers have no way to find out from the outside that the doors are opened already, and the passenger has to ask the driver or the driver has to tell the passenger. As a result, the passenger has to stand in the rain for a while or get wet before entering the car.

Obviously, it is necessary to overcome the aforementioned drawbacks by providing an automobile light emitting device to remind passengers about a car at the front is making a turn to improve the road safety and provide a way to inform passengers about the door lock is opened already and allow the passengers to enter into the car quickly.

### SUMMARY OF THE INVENTION

Therefore, it is a primary objective of the present invention to provide an automobile light emitting device, comprising a plurality of light emitting members, a control unit and an electric connection circuit, wherein each light emitting member is installed at a peripheral surface (such as a fender, a wheel arch panel or a wheel housing panel) outside an automobile wheel, a door handle or a door handle recess of a car door, or a car roof (such as a car antenna, a convertible top rack or an automobile shark fin).

The control unit with a signal light control circuit is provided for controlling a right-turn signal light to blink, such that when the right-turn signal light blinks, the light emitting members installed on corresponding fenders of at least two right wheels also blink, and when the signal light control circuit controls a left-turn signal light to blink, the light emitting members installed on the corresponding fenders of at least two left wheels also blink. Such arrangement can remind passengers, bicycle riders or motorcycle riders to watch out for any car which is ready to make a turn or a street parking, in order to avoid car accidents and improve the road safety of the passengers.

Alternatively, the control unit is linked to a central lock control unit of a car, and the control unit turns on the light emitting member to actively notice that the door lock is opened when the central lock control unit controls and opens the door lock, so that passengers can open the car door and enter into the car immediately, so as to save time and physical strength of the passengers, particularly in poor weather conditions such as a hot sunny day or a rainy day in an outdoor car park without any shelter.

### BRIEF DESCRIPTION OF THE INVENTION

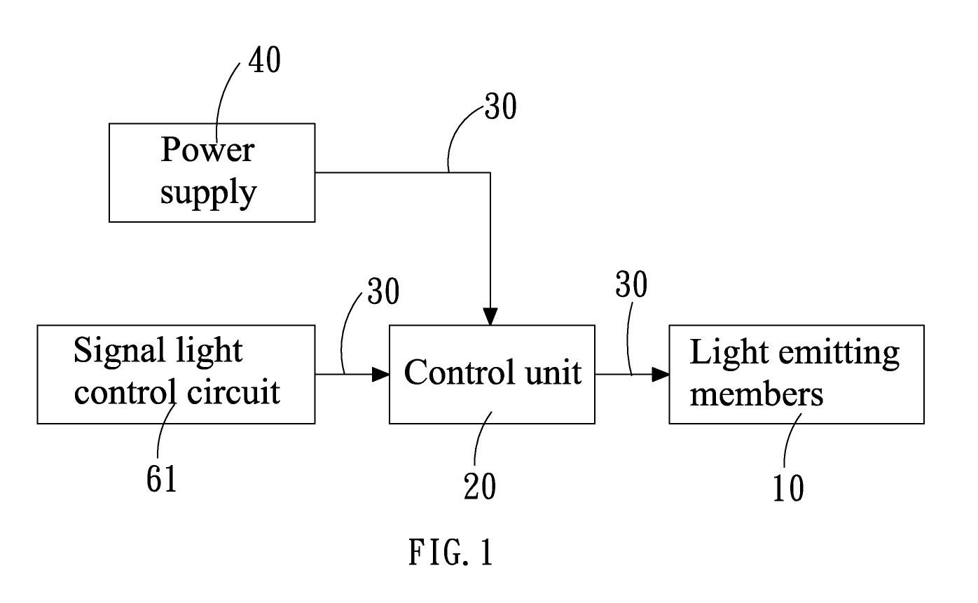

FIG. 1 is a schematic block diagram of an automobile light emitting device in accordance with a first preferred embodiment of the present invention;

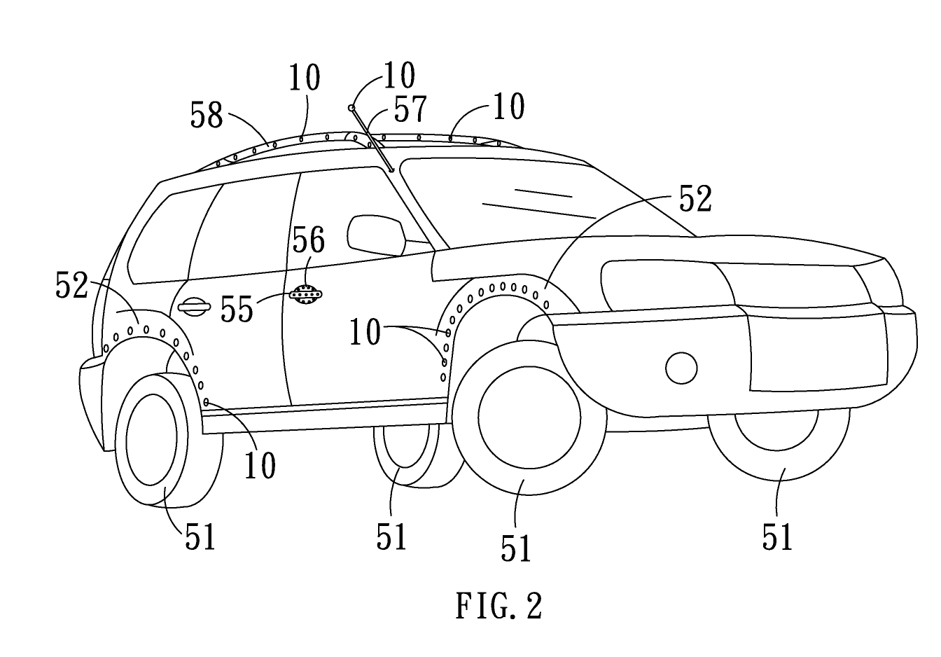

FIG. 2 is a perspective view of an automobile light emitting device installed in a car in accordance with the first preferred embodiment of the present invention;

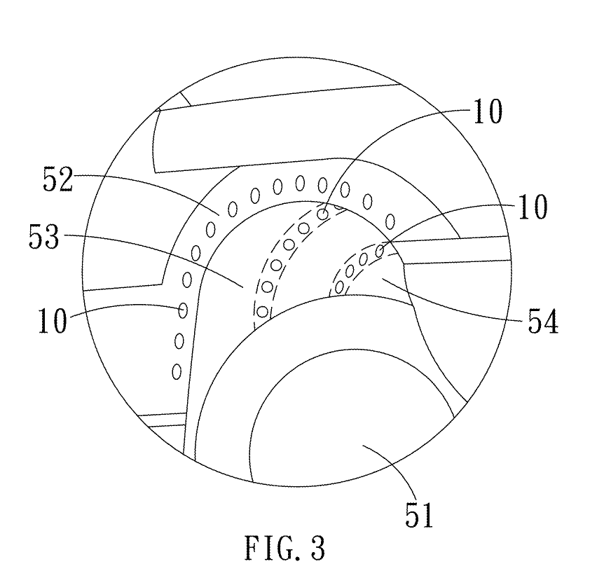

FIG. 3 is a perspective view of an automobile light emitting device installed in a car in accordance with a second preferred embodiment of the present invention;

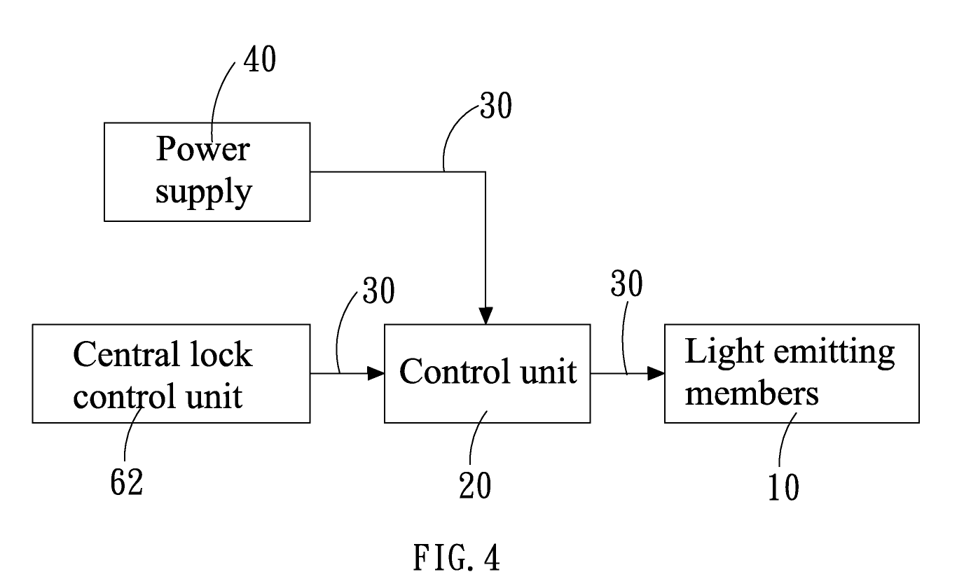

FIG. 4 is a schematic block diagram of an automobile light emitting device in accordance with the second preferred embodiment of the present invention;

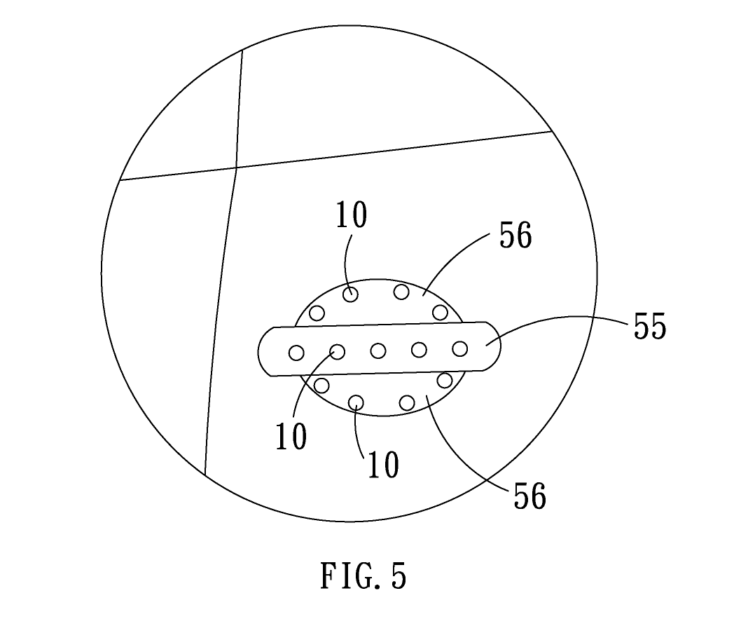

FIG. 5 is a perspective view of an automobile light emitting device installed in a car in accordance with a third preferred embodiment of the present invention;

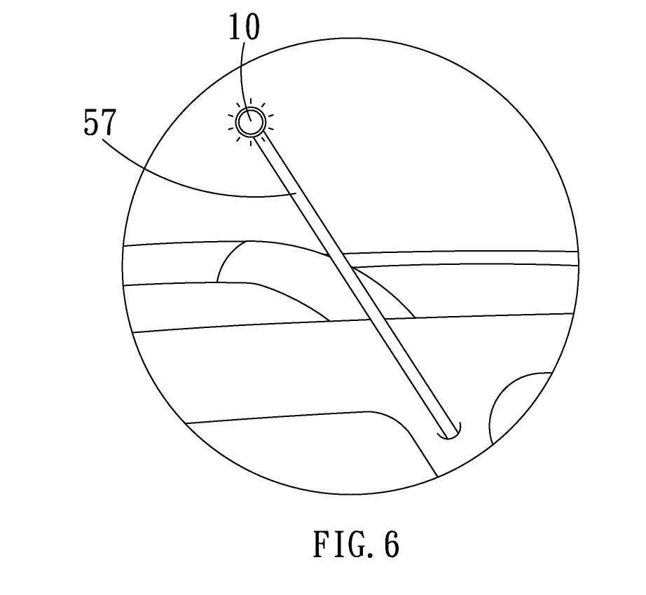

FIG. 6 is a perspective view of an automobile light emitting device installed in a car in accordance with a fourth preferred embodiment of the present invention;

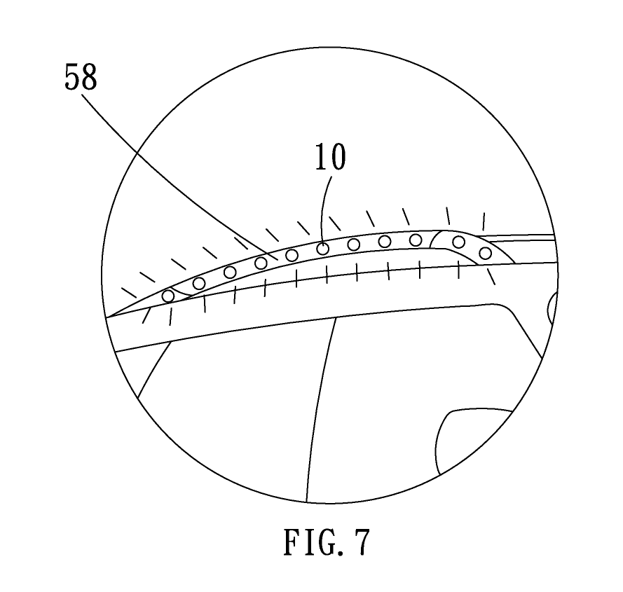

FIG. 7 is a perspective view of an automobile light emitting device installed in a car in accordance with a fifth preferred embodiment of the present invention;

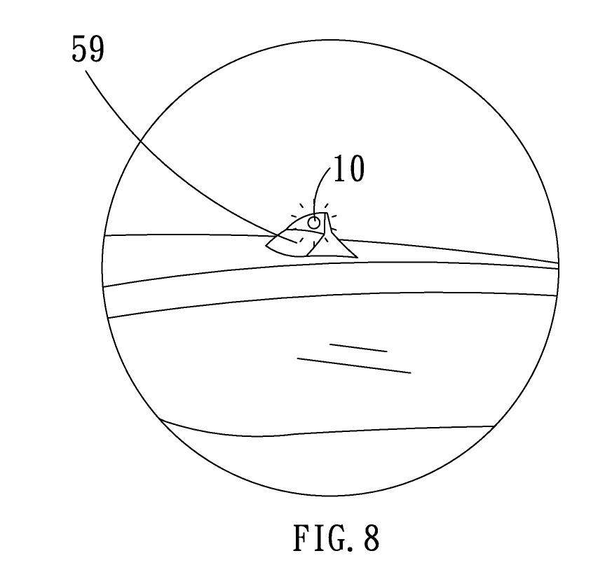

FIG. 8 is a perspective view of an automobile light emitting device installed in a car in accordance with a sixth preferred embodiment of the present invention; and

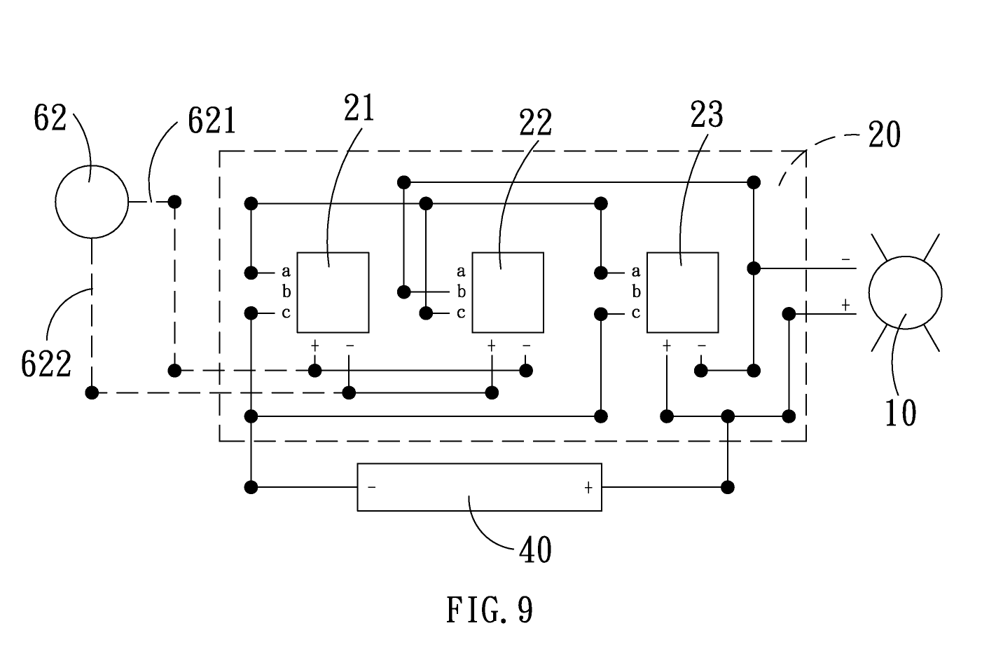

FIG. 9 is a schematic block diagram of a control unit of the present invention.

### DETAILED DESCRIPTION OF THE PREFERRED EMBODIMENTS

The above and further objects and novel features of the invention will more fully be apparent from the following detailed description in connection with the accompanying drawings.

With reference to FIG. 1 for a schematic block diagram of an automobile light emitting device in accordance with a first preferred embodiment of the present invention, the automobile light emitting device comprises a plurality of light emitting members 10, a control unit 20 and an electric connection circuit 30, wherein each light emitting member can be a light emitting diode or a light bulb, and the control unit 20 is electrically coupled to the light emitting members 10 through the electric connection circuit 30, and the electric connection circuit 30 electrically couples a power supply 40 to the control unit 20, so that the control unit 20 can turn on or off the light emitting members 10.

The light emitting members are installed on a peripheral surface outside a wheel of a car, wherein the peripheral surface can be a surface of an automobile fender, a wheel arch panel or a wheel housing panel. With reference to FIG. 2 for a perspective view of each light emitting device installed in a car in accordance with the first preferred embodiment of the present invention, the light emitting member 10 is installed at a fender 52 outside a wheel 51. In the second preferred embodiment as shown in FIG. 3, each light emitting member 10 is installed on a surface of an automobile fender 52, a wheel arch panel 53 or a wheel housing panel 54, wherein the light emitting member 10 emits light towards the wheel 51 and outside the wheel 51. In general, the wheel arch panel 53 is made of plastic and generally called a mudguard, and the wheel housing panel 54 is made of metal and generally called an iron wheel cover. It is noteworthy to point out that the present invention is not limited to the aforementioned materials only.

With reference to FIGS. 2 and 3 for a detailed illustration of the technical characteristics of the aforementioned embodiments, the wheels 51 as shown in FIG. 2 include at least two right wheels and at least two left wheels. It is noteworthy to point out that the four wheels as shown in the figure are provided for the illustration purpose only, but the present invention is not limited to four wheels only. In other words, the car of the present invention may have four wheels or more.

In FIG. 1, the control unit 20 is linked to the automobile signal light control circuit 61, such that if the signal light control circuit 61 controls a right-turn signal light to blink, the control unit 20 will control the corresponding light emitting member 10 outside the right wheel 51 to blink, too. If the signal light control circuit 61 controls a left-turn signal light to blink, the control unit 20 will control the corresponding light emitting members 10 of the left wheel 51 to blink, too. Therefore, automobile light emitting device of the present invention can remind car drivers, motorcycle riders, bicycle riders and passengers about a car at the front or nearby which is ready to make a turn (or making a turn) to avoid car accidents and improve road safety.

Further, if the signal light control circuit 61 controls the right-turn signal light or turns off the left-turn signal light, the control unit 20 will turn off the light emitting members 10 outside all wheels 51.

With reference to FIG. 4 for a schematic block diagram of an automobile light emitting device in accordance with a second preferred embodiment of the present invention, the automobile light emitting device also comprises a plurality of light emitting members 10, a control unit 20 and an electric connection circuit 30, wherein the control unit 20 is linked to the automobile central lock control unit 62, and each light emitting member 10 is installed at a door handle 55 or a door handle recess 56 of a car door in accordance with a third preferred embodiment as shown in FIG. 5, and the car door may be any car door of the car.

Each light emitting member can be installed at a car roof, such as a car antenna 57 installed at the car roof (as shown in FIG. 6), a convertible top rack 58 (as shown in FIG. 7) and an automobile shark fin 59 (as shown in FIG. 8).

In the automobile light emitting device of the second preferred embodiment, if the central lock control unit 62 controls and opens the door lock of the car door, the control unit 20 turns on the light emitting member 10 to actively notify people around about the automobile door lock being opened already, so that the passengers can open the car door and enter into the car immediately. If the passengers have entered into the car and closed the car door and the central lock control unit 62 controls and closes the door lock of the car door, the control unit 20 will turn off the light emitting member 10. Therefore, the light emitting member is provided for informing the passengers that the door lock is opened without the need of waiting for the driver to tell them, so as to save the precious time and physical strength of the passengers, particularly in poor weather conditions, such as a hot sunny day or a rainy day in an outdoor car park without any shelter.

In FIG. 9, the control unit 20 further comprises first, second and third relays 21, 22, 23, and the central lock control unit 62 can issue an open signal 621 to control and open the door lock or a close signal 622 to control and close the door lock. If the central lock control unit 62 issues the open signal 621, the first and third relays 21, 23 are electrically connected to turn on the light emitting member 10. If the close signal 622 is issued, the second relay 22 will not be electrically connected, and the light emitting member 10 will not be turned on.

It is noteworthy to point out that the automobile light emitting device of the present invention has the following advantages:

1. Each light emitting member is linked to the automobile signal light control circuit through the control unit, such that when the left-turn or right-turn signal light is turned on, each light emitting member can be turned on simultaneously to remind pedestrians, passengers, motorcycle riders and bicycle riders to stay away from the moving car or a car ready to make a turn. The invention breaks through the conventional concept of the signal light and adopts an active way of providing the warning effect.

2. Each light emitting member is linked to the automobile central lock control unit through the control unit to inform passengers about the central lock being unlocked and allow the passengers to enter into the car quickly and safely, particularly in poor weather conditions such as a hot sunny day or a rainy day in an outdoor car park without any shelter, so that the passengers need not wait for the driver to tell them, so as to save precious time and physical strength.

3. Each light emitting member is linked to the automobile central lock control unit through the control unit to provide the function of locating a car, wherein the central lock control unit is provided for turning on the light emitting member at the car roof. Therefore, the light emitting device of the invention can be installed at the highest position of the car (such as a car antenna, a convertible rack, or an automobile shark fin) to provide a convenient identification to facilitate car owners to find their cars.

In summation of the description above, the present invention provides a more feasible automobile light emitting device to improve over the prior art and complies with the patent application requirements, and is thus duly file for patent application. While the invention has been described by means of specific embodiments, numerous modifications and variations could be made thereto by those skilled in the art without departing from the scope and spirit of the invention set forth in the claims.

What is claimed is:

1. An automobile light emitting device, comprising:
a plurality of light emitting members, installed on a peripheral surface outside a wheel of a car;
a control unit, linked with a signal light control circuit of the car; and
an electric connection circuit, for electrically coupling the control unit to the light emitting members, and electrically coupling the control unit to a power supply;
thereby, if a signal light control circuit of the car enables a right-turn signal light to blink, the control unit controls the corresponding light emitting member on the peripheral surface of a right wheel to blink, and if the signal light control circuit enables a left-turn signal light to blink, the control unit controls the corresponding light emitting member on the peripheral surface of a left wheel to blink, and if the right-turn signal light or the left-turn signal light is disabled, the control unit controls and turns off the light emitting members on the peripheral surfaces of all wheels.

2. The automobile light emitting device of claim 1, wherein the light emitting member is a light emitting diode or a light bulb.

3. The automobile light emitting device of claim 1, wherein the peripheral surface is a surface of an automobile fender, a wheel arch panel, or a wheel housing panel.

4. The automobile light emitting device of claim 1, wherein the wheels include at least two right wheels and at least two left wheels.

5. An automobile light emitting device, comprising:
a plurality of light emitting members, installed at a door handle or a door handle recess of a car;
a control unit, linked with an central lock control unit of the car; and
an electric connection circuit, for electrically coupling the control unit to the light emitting members, and electrically coupling the control unit to a power supply;
thereby if the central lock control unit controls and opens a door lock of a car door, the control unit turns on the light emitting members, and if the central lock control unit controls and closes the door lock of the car door, the control unit turns off the light emitting members.

6. The automobile light emitting device of claim 5, wherein the light emitting member is a light emitting diode or a light bulb.

7. The automobile light emitting device of claim 5, wherein the control unit further comprises first, second and third relays.

8. An automobile light emitting device, comprising:
a plurality of light emitting members, installed at a car roof of a car;
a control unit, linked with an automobile central lock control unit; and
an electric connection circuit, for electrically coupling the control unit to the light emitting members, and electrically coupling the control unit to a power supply;
thereby if the central lock control unit controls and opens a door lock of a car door, the control unit turns on the light emitting members, and if the central lock control unit controls and closes the door lock of the car door, the control unit turns off the light emitting members.

9. The automobile light emitting device of claim 8, wherein the light emitting member is a light emitting diode or a light bulb.

10. The automobile light emitting device of claim 8, wherein the light emitting members are installed at a car antenna, a convertible top rack or an automobile shark fin of the car roof.

11. The automobile light emitting device of claim 8, wherein the control unit further comprises first, second and third relays.
